(19) United States
(12) Patent Application Publication
(10) Pub. No.: US 2025/0045042 A1
(43) Pub. Date: Feb. 6, 2025

(54) MACHINE LEARNING FIRMWARE OPTIMIZATION

(71) Applicant: Micron Technology, Inc., Boise, ID (US)

(72) Inventors: Saideep Tiku, Fort Collins, CO (US); Poorna Kale, Folsom, CA (US)

(21) Appl. No.: 18/767,789

(22) Filed: Jul. 9, 2024

Related U.S. Application Data
(60) Provisional application No. 63/517,028, filed on Aug. 1, 2023.

(51) Int. Cl. G06F 8/658; G06F 8/71; G06N 3/086; G06N 3/092

(52) U.S. Cl. CPC G06F 8/658; G06F 8/71; G06N 3/086; G06N 3/092

(57) ABSTRACT

Machine learning based firmware optimization can include iteratively producing different versions of firmware for operating a physical memory device within a respective defined acceptable range of values for different operational parameters. Iteratively producing different versions of firmware can include deploying an initial version of firmware on a digital twin of the physical memory device, determining an initial value of a performance parameter based on operation of the digital twin according to the initial version of firmware, producing a modified version of firmware, deploying the modified version of firmware on the digital twin, and determining a next value of the performance parameter based on operation of the digital twin according to the modified version of firmware. One of the different versions of firmware that achieves a target value for the performance parameter can be provided for deployment on the physical memory device.

### PRIORITY INFORMATION

This application claims the benefit of U.S. Provisional Application No. 63/517,028, filed on Aug. 1, 2023, the contents of which are incorporated herein by reference.

### TECHNICAL FIELD

The present disclosure relates generally to apparatuses, non-transitory machine-readable media, and methods associated with machine learning firmware optimization.

### BACKGROUND

A computing device can be, for example, a personal laptop computer, a desktop computer, a server, a smart phone, smart glasses, a tablet, a wrist-worn device, a mobile device, a digital camera, and/or redundant combinations thereof, among other types of computing devices. Computing devices can be used to implement artificial neural networks (ANNs). Computing devices can also be used to train the ANNs.

ANNs are networks that can process information by modeling a network of neurons, such as neurons in a human brain, to process information (e.g., stimuli) that has been sensed in a particular environment. Similar to a human brain, neural networks typically include a multiple neuron topology, which can be referred to as artificial neurons. An ANN operation refers to an operation that processes inputs using artificial neurons to perform a given task. The ANN operation may involve performing various machine learning algorithms to process the inputs. Example tasks that can be processed by performing ANN operations can include machine vision, speech recognition, machine translation, social network filtering, and medical diagnosis, among others.

### BRIEF DESCRIPTION OF THE DRAWINGS

FIG. 1 is a block diagram of a system for machine learning firmware optimization.

FIG. 2 is a flow diagram for machine learning firmware optimization.

FIG. 3 is a flow diagram corresponding to a method for machine learning firmware optimization.

FIG. 4 is a block diagram of a computer system in which embodiments may operate.

### DETAILED DESCRIPTION

The present disclosure describes apparatuses and methods related to machine learning firmware optimization. Firmware is a specific class of software that provides low level control for specific hardware of a device, such as a memory device. Firmware can provide basic functionality to an electronic device or more advanced functionality such as an operating system, performing control, monitoring, and data manipulation functions. Firmware may be stored in non-volatile memory of an electronic device. However, firmware can be difficult, costly, or slow to create in a manner that keeps pace with greater complexity of memory devices and shorter development schedules. Firmware is typically coded at a low level, including inline assembly and may be gated by hardware development. After a version of firmware is produced, it may be difficult, costly, or slow to test efficiently.

Embodiments of the present disclosure address the above deficiencies and other deficiencies of previous approaches. For a memory device, given one or more target values for performance parameters and a set of optimizable operational parameters for which an acceptable range is specified, a machine learning framework can attempt to produce a set of acceptable solutions in terms of firmware for operating the memory device. The machine learning framework can be a deep learning framework making use of reinforcement learning, a genetic algorithm, or combinations thereof.

Embodiments can include the generation of a digital twin of the memory device. A digital twin is a digital representation of an intended or actual physical device (e.g., the physical memory device) that serves as an effectively indistinguishable digital counterpart for practical purposes, such as simulation, integration, testing, monitoring, and maintenance. The machine learning framework can iteratively produce different versions of firmware, deploy the different versions of firmware on the digital twin, determine values of the performance parameters of the memory device based on operation of the digital twin according to the different versions of firmware, and attempt to reach solutions that produce performance parameters that meet the target values. One or more acceptable versions of firmware can be produced that meet the target values for the performance parameters. Such approaches can be more resource, cost, and time efficient than previous approaches that rely on tweaking firmware and testing it on physical devices. Such approaches may also achieve more optimal firmware solutions that produce target values of performance parameters of the memory device.

As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

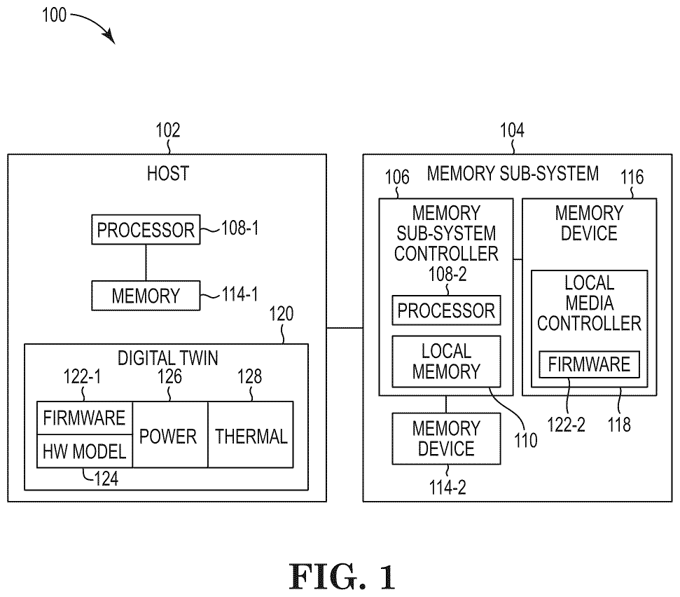

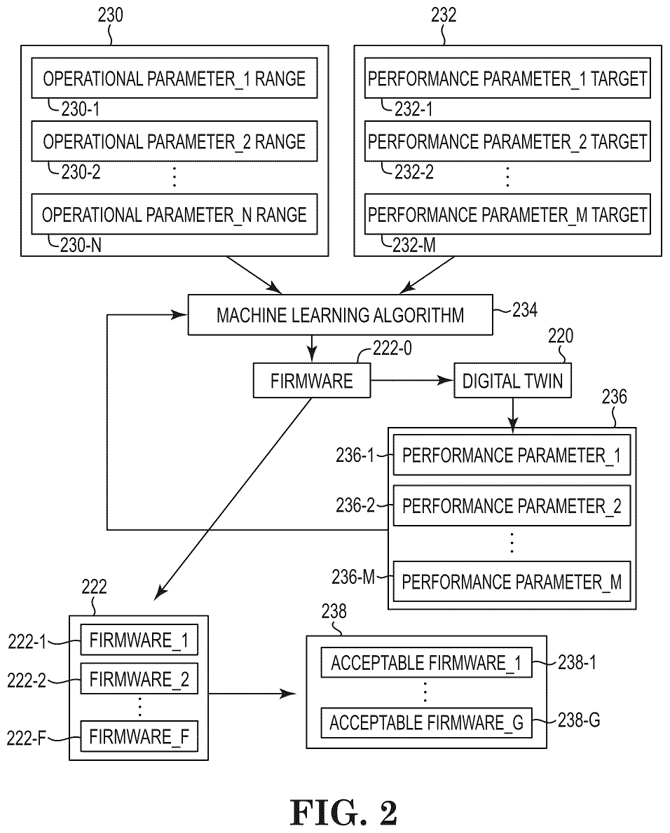

The figures herein follow a numbering convention in which the first digit or digits correspond to the drawing figure number and the remaining digits identify an element or component in the drawing. Similar elements or components between different figures may be identified by the use of similar digits. For example, 120 may reference element “20” in FIG. 1, and a similar element may be referenced as 220 in FIG. 2. Analogous elements within a Figure may be referenced with a hyphen and extra numeral or letter. See, for example, elements 230-1, 230-2, . . . , 230-N in FIG. 2. Such analogous elements may be generally referenced without the hyphen and extra numeral or letter. For example, elements 230-1, . . . , 230-N may be collectively referenced as 230. As used herein, the designators “F”, “G”, “M”, and “N”, particularly with respect to reference numerals in the drawings, indicates that a number of the particular feature so designated can be included. As will be appreciated, elements shown in the various embodiments herein can be added, exchanged, and/or eliminated so as to provide a number of additional embodiments. In addition, as will be appreciated, the proportion and the relative scale of the elements provided in the figures are intended to illustrate certain embodiments of the present invention and should not be taken in a limiting sense.

FIG. 1 is a block diagram of a system 100 for machine learning firmware optimization. The memory sub-system 104 can include media, such as one or more volatile memory devices 114-2, one or more non-volatile memory devices 116, or a combination thereof. The volatile memory devices 114-1, 114-2 illustrated in FIG. 1 can be, but are not limited to, random access memory (RAM), such as dynamic random access memory (DRAM), synchronous dynamic random access memory (SDRAM), and resistive DRAM (RDRAM). The memory sub-system 104 can also include additional circuitry or components that are not illustrated. In some embodiments, the memory sub-system 104 can include address circuitry (e.g., a row decoder and a column decoder) that can receive an address from the memory sub-system controller 106 and decode the address to access the non-volatile memory devices 116.

A memory sub-system 104 can be a storage device, a memory module, or a hybrid of a storage device and memory module. Examples of a storage device include an SSD, a flash drive, a universal serial bus (USB) flash drive, an embedded Multi-Media Controller (eMMC) drive, a Universal Flash Storage (UFS) drive, a secure digital (SD) card, and a hard disk drive (HDD). In at least one embodiment, the memory sub-system 104 is an automotive grade SSD. Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 includes a host system 102 that is coupled to one or more memory sub-systems 104. In some embodiments, the host system 102 is coupled to different types of memory sub-systems 104. As used herein, “coupled to” or “coupled with” generally refers to a connection between components, which can be an indirect communicative connection or direct communicative connection (e.g., without intervening components), whether wired or wireless, including connections such as electrical, optical, magnetic, and the like.

The host system 102 includes or is coupled to processing resources, memory resources, and network resources. As used herein, “resources” are physical or virtual components that have a finite availability within a computing system 100. For example, the processing resources include a processor 108-1 (or a number of processing devices), the memory resources include volatile memory 114-1 for primary storage, and the network resources include as a network interface (not specifically illustrated). Although not specifically illustrated, the host system 102 can include non-volatile memory for persistent storage of data. The processor 108-1 can be one or more processor chipsets, which can execute a software stack. The processor 108-1 can include one or more cores, one or more caches, a memory controller (e.g., NVDIMM controller), and a storage protocol controller (e.g., PCIe controller, SATA controller, etc.). The host system 102 uses the memory sub-system 104, for example, to write data to the memory sub-system 104 and read data from the memory sub-system 104.

Although not specifically illustrated, the host system 102 can include artificial intelligence (AI) accelerators such as deep learning accelerators (DLAs), which can be utilized to train ANN models. As used herein, AI refers to the ability to improve an apparatus through “learning” such as by storing patterns and/or examples which can be utilized to take actions at a later time. Deep learning refers to a device's ability to learn from data provided as examples. Deep learning can be a subset of AI. Neural networks, among other types of networks, can be classified as deep learning. In various examples, processors 108-1 are described for performing the examples described herein. AI accelerators can also be utilized to perform the examples described herein instead of or in concert with the processors 108-1.

The host system 102 can be coupled to the memory sub-system 104 via a physical host interface. Examples of a physical host interface include, but are not limited to, a serial advanced technology attachment (SATA) interface, a PCIe interface, universal serial bus (USB) interface, Fibre Channel, Serial Attached SCSI (SAS), Small Computer System Interface (SCSI), a double data rate (DDR) memory bus, a dual in-line memory module (DIMM) interface (e.g., DIMM socket interface that supports Double Data Rate (DDR)), Open NAND Flash Interface (ONFI), Double Data Rate (DDR), Low Power Double Data Rate (LPDDR), or any other interface. The physical host interface can be used to transmit data between the host system 102 and the memory sub-system 104. The host system 102 can further utilize an NVM Express (NVMe) interface to access the non-volatile memory devices 116 when the memory sub-system 104 is coupled with the host system 102 by the PCIe interface. The physical host interface can provide an interface for passing control, address, data, and other signals between the memory sub-system 104 and the host system 102. In general, the host system 102 can access multiple memory sub-systems via a same communication connection, multiple separate communication connections, and/or a combination of communication connections.

The non-volatile memory devices 116 can be not-and (NAND) type flash memory. NAND type flash memory includes, for example, two-dimensional NAND (2D NAND) and three-dimensional NAND (3D NAND). The non-volatile memory devices 116 can be other types of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, electrically erasable programmable read-only memory (EEPROM), and three-dimensional cross-point memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased.

Each of the non-volatile memory devices 116 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the non-volatile memory devices 116 can include one or more arrays of memory cells such as SLCs, MLCs, TLCs, QLCs, or any combination of such. In some embodiments, a particular memory device can include an SLC portion, an MLC portion, a TLC portion, a QLC portion, or a PLC portion of memory cells. The memory cells of the non-volatile memory devices 116 can be grouped as pages that can refer to a logical unit of the memory device used to store data. With some types of memory (e.g., NAND), pages can be grouped to form blocks (e.g., erase blocks).

The memory sub-system controller 106 (or controller 106 for simplicity) can communicate with the non-volatile memory devices 116 to perform operations such as reading data, writing data, erasing data, and other such operations at the non-volatile memory devices 116. The memory sub-system controller 106 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 106 can be a microcontroller, special purpose logic circuitry (e.g., a field programmable gate array (FPGA), an application specific integrated circuit (ASIC), etc.), or other suitable circuitry.

The memory sub-system controller 106 can include a processor 108-2 configured to execute instructions stored in local memory 110. The local memory 110 of the memory sub-system controller 106 can be an embedded memory configured to store instructions for performing various processes, operations, logic flows, and routines that control operation of the memory sub-system 104, including handling communications between the memory sub-system 104 and the host system 102. The local memory 110 can be volatile memory, such as static random access memory (SRAM).

In some embodiments, the local memory 110 can include memory registers storing memory pointers, fetched data, etc. The local memory 110 can also include ROM for storing micro-code, for example. While the example memory sub-system 104 has been illustrated as including the memory sub-system controller 106, in another embodiment of the present disclosure, a memory sub-system 104 does not include a memory sub-system controller 106, and can instead rely upon external control (e.g., provided by an external host, or by a processor or controller separate from the memory sub-system 104).

In general, the memory sub-system controller 106 can receive information or operations from the host system 102 and can convert the information or operations into instructions or appropriate information to achieve the desired access to the non-volatile memory devices 116 and/or the volatile memory devices 110, 114-2. The memory sub-system controller 106 can be responsible for other operations such as media management operations (e.g., wear leveling operations, garbage collection operations, defragmentation operations, read refresh operations, etc.), error detection and/or correction operations, encryption operations, caching operations, and address translations between a logical address (e.g., logical block address) and a physical address (e.g., physical block address) associated with the non-volatile memory devices 116. The memory sub-system controller 106 can use error correction code (ECC) circuitry to provide the error correction and/or error detection functionality. The ECC circuitry can encode data by adding redundant bits to the data. The ECC circuitry can decode error encoded data by examining the ECC encoded data to check for any errors in the data. In general, the ECC circuitry can not only detect the error but also can correct a subset of the errors it is able to detect. The memory sub-system controller 106 can further include host interface circuitry to communicate with the host system 102 via the physical host interface. The host interface circuitry can convert a query received from the host system 102 into a command to access the non-volatile memory devices 116 and/or the volatile memory device 114-2 as well as convert responses associated with the non-volatile memory devices 116 and/or the volatile memory device 114-2 into information for the host system 102.

In some embodiments, the non-volatile memory devices 116 include a local media controller 118 that operates in conjunction with memory sub-system controller 106 to execute operations on one or more memory cells of the memory devices 116. An external controller (e.g., memory sub-system controller 106) can externally manage the non-volatile memory device 116 (e.g., perform media management operations on the memory device 116). In some embodiments, a memory device 116 is a managed memory device, which is a raw memory device combined with a local controller (e.g., local controller 118) for media management within the same memory device package. An example of a managed memory device is a managed NAND (mNAND) device.

The host system 102 can send requests to the memory sub-system 104, for example, to store data in the memory sub-system 104 or to read data from the memory sub-system 104. The data to be written or read, as specified by a host request, is referred to as “host data.” A host request can include logical address information. The logical address information can be a logical block address (LBA), which may include or be accompanied by a partition number. The logical address information is the location the host system associates with the host data. The logical address information can be part of metadata for the host data. The LBA may also correspond (e.g., dynamically map) to a physical address, such as a physical block address (PBA), that indicates the physical location where the host data is stored in memory.

The host system 102 can create a digital twin 120 of the non-volatile memory device 116. Although the non-volatile memory device 116 is used as an example of a physical memory device for which the host 102 can create a digital twin for purposes of firmware optimization, embodiments are not so limited. Firmware for other physical memory devices, such as local memory 110, volatile memory device 114-2, etc., can be optimized according to embodiments described herein. The digital twin 120 can include various components that in combination present a virtual/digital simulation of the physical memory device 116. Examples of such components include development firmware 122-1, a hardware model 124, a power model 126 of the physical memory device 116, and a thermal model 128 of the physical memory device 116. The various components of the digital twin 120 collectively capture the overall behavior of the physical memory device 116.

The lowest layer of the digital twin 120 is the hardware model 124 of the physical memory device 116. The hardware model 124 captures physical abstractions of the various hardware building blocks of the physical memory device 116. The hardware model 124 can be a register transfer level (RTL) abstraction using a hardware description language such as Verilog or VHDL that are fed into a logic synthesis tool, which can create a logic gate-level abstraction of the design of the physical memory device 116. The hardware model 124 can include abstractions of physical registers (for state information), combinational logic (for nest state inputs), and clocks (for control of timing of state changes), among other components of the physical memory device 116. The hardware model 124 can capture physical abstractions of the physical memory device 116 at the embedded component level (e.g., physical locations of components on the chip comprising the physical memory device 116).

The development firmware 122-1 of the digital twin 120 can include target values for performance parameters and/or acceptable ranges of values for different operational parameters annotated in source code (e.g., C, Assembly, Symbol file, etc.) of the development firmware 122-1 at the time of declaration/definition. Examples of performance parameters for a memory device include random read performance, sequential write performance, input/output operations per second (IOPS), bandwidth (e.g., megabytes per second), etc. Target values for any performance parameter can be specified and the firmware can be optimized to try to achieve those target values. Examples of operational parameters include buffer depth, digital voltage scaling, digital frequency scaling, dynamic voltage frequency scaling, thermal constraints, etc. The development firmware 122-1 can be iteratively adjusted to change, directly or indirectly, the values of the operational parameters with the goal of producing values of performance parameters that are closer to the targets. The values of the operational parameter can be bounded within a range specified by the manufacturer of the physical memory device 116 and/or by a customer (e.g., based on a desired implementation of the physical memory device 116).

The power model 126 is configured to provide an indication of power consumed by the digital twin 120 as operated by the development firmware 122-1 (as the development firmware 122-1 drives the hardware model 124). The indication of power consumed by the digital twin 120 represents the actual power that would be consumed by the physical memory device 116 if operated according to a production equivalent to the development firmware 122-1. The thermal model 128 is configured to provide an indication of a thermal response of the digital twin 120 as operated by the development firmware 122-1 (as the development firmware 122-1 drives the hardware model 124). The thermal model 128 can be further configured to provide the indication of the thermal response based on the indication of power consumed. The output of the power model 126 can be fed to the thermal model 128 to provide more a more accurate indication of the thermal response. The indication of the thermal response represents the actual thermal response of the physical memory device 116 if operated according to a production equivalent firmware 122-2 to the development firmware 122-1.

The host system 102 can store instructions (e.g., in the volatile memory device 114-1 and/or in a non-volatile memory device) executable by the processor 108-1 to deploy an initial version of firmware 122-1 that defines a respective acceptable range of values for each of a plurality of operational parameters on the digital twin 120 of a physical memory device 116. The instructions can be executed to determine an initial value of a performance parameter based on operation of the digital twin 120 according to the initial version of firmware 122-1. The instructions can be executed to produce a modified version of firmware 122-1 and deploy the modified version of firmware 122-1 on the digital twin 120. The instructions to produce the modified version of firmware 122-1 can include instructions to modify values of one or more of the operational parameters (within the defined range of acceptable values). Only one version of firmware 122-1 is illustrated in FIG. 1, but the modified version can replace the initial version (or a previous next version) in the digital twin 120. The instructions can be executed to determine a next value of the performance parameter based on operation of the digital twin 120 according to the modified version of firmware 122-1. The instructions can be executed to provide one of the different versions of firmware 122-2 that achieves a target value for the performance parameter for deployment on the physical memory device 116.

FIG. 2 is a flow diagram for machine learning firmware optimization. Ranges for various operational parameters 230 and target values for various performance parameters 232 can be fed into a machine learning algorithm 234. The operational parameters 230 are illustrated as including a range of acceptable values for a first operational parameter 230-1, a range of values for a second operational parameter 230-2, and a range of values for an Nth operational parameter 230-N. The target values for performance parameters 232 are illustrated as including a target value for a first performance parameter 232-1, a target value for a second performance parameter 232-2, and a target value for an Mth performance parameter 232-M.

The machine learning algorithm 234 can create a development version of firmware 222-0 (or modify an already existing initial version of firmware) for operating a digital twin 220 of a physical memory device based on the acceptable ranges of values for the operational parameters 230 and the target values for the performance parameters 232. The digital twin 220 can include a model of hardware of the physical memory device. The model of hardware can comprise abstractions of hardware components of the physical memory device. The digital twin 220 may also include a power model of the physical memory device and/or a thermal model of the physical memory device, as described herein.

A value of various performance parameters 236 of the digital twin 220 can be determined based on operation thereof according to the (various versions of) development firmware 220-0. The values of the various performance parameters 236 are illustrated as including a value of a first performance parameter 236-1, a value of a second performance parameter 236-2, and a value of an Mth performance parameter 236-M. The machine learning algorithm 234 can iteratively optimize the development firmware 222-0 with respect to the target values for the performance parameters 232 defined in the development firmware 222-0. The optimization can be geared toward driving the values of the performance parameters 236 toward the target values 232.

Each iterative round of optimization can produce a unique version of the development firmware 222, which is illustrated as a first version of development firmware 222-1, a second version of development firmware 222-2, and an Fth version of development firmware 222-F. In some embodiments, the iterative optimization can continue by producing a modified version of the development firmware 222, operating the digital twin 220 according to the modified version of the development firmware 222, and determining a next value of the performance parameter 236 based on operation of the digital twin 220 according to the modified development firmware 222 until the next value of the performance parameter 236 meets the target value 232.

Different versions of development firmware 222 can be stored, for example, to facilitate later testing for different physical memory devices a similar memory device with different acceptable ranges of operational parameters 230 and/or different target values for performance parameters 232. Operational firmware can be created to operate the physical memory device based on the optimized development firmware 222. In some embodiments, multiple acceptable versions of firmware 238 can be provided for deployment to physical memory devices. As illustrated, the multiple acceptable versions of firmware 238 include a first acceptable version of firmware 238-1 and a Gth acceptable version of firmware 238-G. A version of firmware may be considered to be acceptable if it produces values of performance parameters 236 that achieve respective target values for any performance parameters 232 for which a target value has been received. Particular implementations may include lesser or fewer defined target values for performance parameters 232 than other implementations.

One example of the machine learning algorithm can utilize a reinforcement learning algorithm. Reinforcement learning is concerned with how intelligent agents should take actions in an environment in order to maximize the notion of cumulative reward. Reinforcement learning does not require labeled input/output pairs or correction of sub-optimal actions. Instead, the focus is on finding a balance between exploration of options that present unknown results with exploration of options that present known results. The reinforcement learning algorithm can modify the operational parameters 230 within the constraints of their acceptable ranges to produce different versions of development firmware 222-0. The digital twin 220 can be operated according to the different versions of the development firmware 222-0 to determine values of the performance parameters 236 that result therefrom. In this context, the reinforcement learning algorithm is rewarded when the values of the performance parameters 236 move closer to the target values of the performance parameters 232 than in a previous iteration. The reinforcement learning algorithm can seek to maximize a reward function through successive iterations of developing and testing different versions of the development firmware 222-0. The use of a reinforcement learning algorithm can be advantageous for optimizing firmware for operating a physical memory device because there is not a model of the physical memory device that provides an analytical solution to the question of how to optimize the firmware to provide target values for performance parameters of the physical memory device, but through simulation of operation of the memory device by the digital twin, the reinforcement learning algorithm can interact with the environment of the digital twin to provide a simulation-based optimization solution.

Another example of the machine learning algorithm 234 is a genetic algorithm. A genetic algorithm is a metaheuristic designed to find, generate, tune, or select a heuristic that may provide a sufficiently good solution to an optimization problem, where the algorithm is inspired by the process of natural selection. A genetic algorithm can mimic biologically inspired operators such as mutation, crossover, and selection. A population of candidate solutions, each with a set of properties (e.g., operational parameters 230) that can be mutated (altered) is evolved toward the production of better solutions (e.g., target values for parameters 232). The genetic algorithm can include a genetic representation of the solution domain and a fitness function (e.g., target values for performance parameters 232) to evaluate the solution domain.

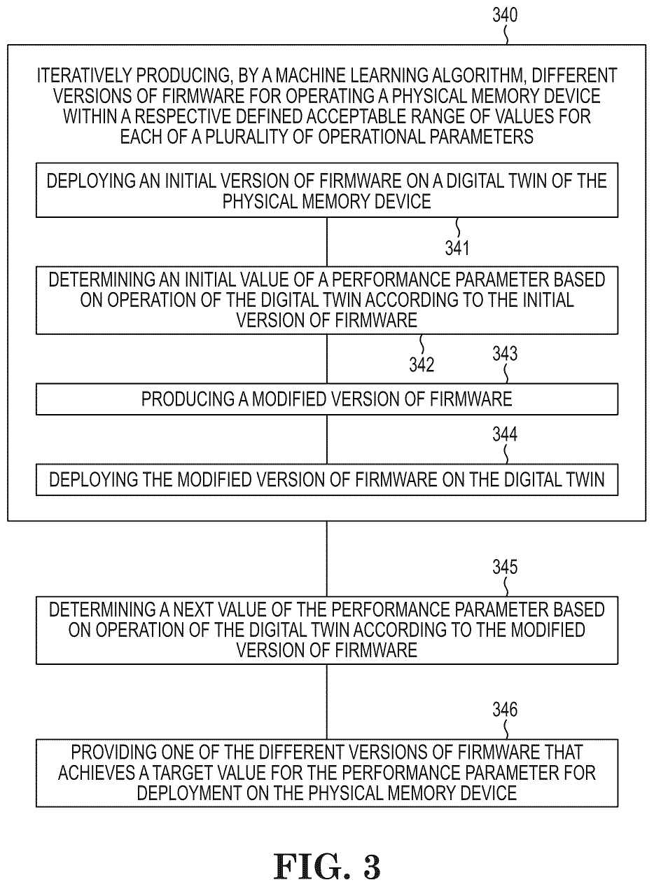

FIG. 3 is a flow diagram corresponding to a method for machine learning firmware optimization. The method may be performed, in some examples, using a computing system such as those described with respect to FIG. 1. The method can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method is performed by or using the host 102 shown in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At 340, the method can include iteratively producing, by a machine learning algorithm, different versions of firmware for operating a physical memory device within a respective defined acceptable range of values for each of a plurality of operational parameters. Examples of the machine learning algorithm include a reinforcement learning algorithm and a genetic algorithm, among others.

At 341, iteratively producing different versions of firmware can include deploying an initial version of firmware on a digital twin of the physical memory device. At 342, iteratively producing different versions of firmware can include determining an initial value of a performance parameter based on operation of the digital twin according to the initial version of firmware. At 343, iteratively producing different versions of firmware can include producing a modified version of firmware. At 344, iteratively producing different versions of firmware can include deploying the modified version of firmware on the digital twin.

At 345, the method can include determining a next value of the performance parameter based on operation of the digital twin according to the modified version of firmware. Although not specifically illustrated, the method can further include iteratively producing different versions of firmware until a threshold quantity of the different versions of firmware yield a next value of the performance parameter that achieves the target value. In some embodiments, different versions of firmware can be stored regardless of whether the different versions of firmware yield a next value of the performance parameter that achieves the target value. Such storage can be useful for testing the different versions of firmware for different performance parameters. The different versions of firmware can be deployed iteratively on the digital twin and a respective value of a different performance parameter (e.g., a second performance parameter) can be determined iteratively based on operation of the digital twin according to the different versions of firmware.

At 346, the method can include providing one of the different versions of firmware that achieves a target value for the performance parameter for deployment on the physical memory device. In some embodiments, the one of the different versions of firmware can be provided for deployment on any physical memory device having a same part number. For example, the firmware can be optimized for a particular make and model of a physical memory device (e.g., by a manufacturer of the physical memory device) and then deployed with any such devices that are sold by the manufacturer.

One of the different versions of firmware that achieves a different target value for the different performance parameter can be provided for deployment on the physical memory device. For example, one of the different versions of firmware may advantageously provide a value of the second performance parameter that is closer to the target value for the second performance parameter than a previous version of firmware. In some instances, it may be more important that the firmware cause the physical memory device to provide a value of the second performance parameter that is closer to its target than the first performance parameter (e.g., if in a given instance random read speed is more important than sequential write speed). In some embodiments, more than one iteratively produced version of firmware can achieve respective target values for multiple performance parameters and one of those versions of firmware can be selected based on a particular performance parameter being closer to its respective target value (e.g., where the particular performance parameter is deemed to be more important). Some embodiments can include iteratively producing different versions of firmware for a plurality of performance parameters and one of the different versions of firmware that achieves a respective target parameter for each of the plurality of performance parameters can be provided for deployment on the physical memory device.

Although not specifically illustrated, the method can include providing a respective indication of power consumed by the digital twin as operated by each different version of firmware. The method can include providing a respective indication of a thermal response of the digital twin as operated by each different version of firmware. Such information can be stored in association with the different versions of firmware and optionally made available to a customer purchasing the physical memory device to enable the customer to select a version of firmware based on power and/or thermal performance of the memory device. Power and/or thermal performance may be important to the customer for a particular application.

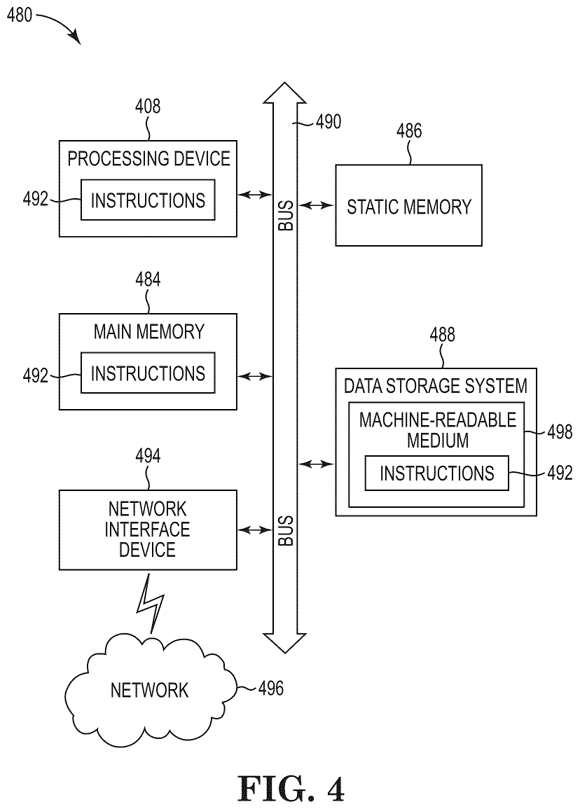

FIG. 4 is a block diagram of a computer system 480 in which embodiments may operate. A set of instructions 492 for causing a machine to perform any of the methodologies discussed herein can be executed within the computer system 480. In some embodiments, the computer system 480 can correspond to a host system that includes, is coupled to, or utilizes a memory sub-system (e.g., the memory sub-system 104 of FIG. 1). The computer system 480 can be used to perform the operations described herein (e.g., to perform operations by the processors 108-1, 108-2 of FIG. 1). In alternative embodiments, a machine can be connected (e.g., networked) to other machines in a local area network (LAN), an intranet, an extranet, the Internet, and/or wireless network. A machine can operate in the capacity of a server or a client machine in client-server network environment, as a peer machine in a peer-to-peer (or distributed) network environment, or as a server or a client machine in a cloud computing infrastructure or environment.

A machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. The term “machine” shall also be taken to include any collection of machines that individually or jointly execute a set (or multiple sets) of instructions to perform any one or more of the methodologies discussed herein.

The computer system 480 includes a processing device (e.g., processor) 408, a main memory 484 (e.g., ROM, flash memory, DRAM, etc.), a static memory 486 (e.g., flash memory, SRAM, etc.), and a data storage system 488, which communicate with each other via a bus 490.

The processing device 408 represents one or more general-purpose processing devices such as a microprocessor, a central processing unit, or the like. More particularly, the processing device 408 can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device 408 can also be one or more special-purpose processing devices such as an application specific integrated circuit (ASIC), a field programmable gate array (FPGA), a digital signal processor (DSP), network processor, or the like. The processing device 408 is configured to execute instructions 492 for performing the operations and steps discussed herein. The computer system 480 can further include a network interface device 494 to communicate over the network 496.

The data storage system 488 can include a machine-readable storage medium 498 (also known as a computer-readable medium) on which is stored one or more sets of instructions 492 or software embodying any one or more of the methodologies or functions described herein. The instructions 492 can also reside, completely or at least partially, within the main memory 484 and/or within the processing device 408 during execution thereof by the computer system 480, the main memory 484 and the processing device 408 also constituting machine-readable storage media. The machine-readable storage medium 498, data storage system 488, and/or main memory 484 can correspond to the memory sub-system 104 of FIG. 1.

In one embodiment, the instructions 492 include instructions to implement functionality corresponding to machine learning firmware optimization. While the machine-readable storage medium 498 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies described herein. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

Embodiments also relate to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

Embodiments can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a ROM, RAM, magnetic disk storage media, optical storage media, flash memory devices, etc.

In the foregoing specification, embodiments have been described with reference to specific example embodiments thereof. It will be evident that various modifications can be made thereto without departing from the broader spirit and scope of embodiments as set forth in the following claims. The specification and drawings are, accordingly, to be regarded in an illustrative sense rather than a restrictive sense.

What is claimed is:

1. A method for machine learning firmware optimization, comprising:
iteratively producing, by a machine learning algorithm, different versions of firmware for operating a physical memory device within a respective defined acceptable range of values for each of a plurality of operational parameters;
wherein iteratively producing different versions of firmware comprises:
deploying an initial version of firmware on a digital twin of the physical memory device;
determining an initial value of a performance parameter based on operation of the digital twin according to the initial version of firmware;
producing a modified version of firmware;
deploying the modified version of firmware on the digital twin; and
determining a next value of the performance parameter based on operation of the digital twin according to the modified version of firmware; and
providing one of the different versions of firmware that achieves a target value for the performance parameter for deployment on the physical memory device.

2. The method of claim 1, further comprising iteratively producing different versions of firmware until a threshold quantity of the different versions of firmware yield a next value of the performance parameter that achieves the target value.

3. The method of claim 2, further comprising:
storing a plurality of different versions of firmware regardless of whether the plurality of different versions of firmware yield a next value of the performance parameter that achieves the target value;
iteratively deploying the plurality of different versions of firmware on the digital twin;
iteratively determining a respective value of a different performance parameter based on operation of the digital twin according to the plurality of different versions of firmware; and
providing one of the plurality of different versions of firmware that achieves a different target value for the different performance parameter for deployment on the physical memory device.

4. The method of claim 1, further comprising iteratively producing different versions of firmware as defined in claim 1 for a plurality of performance parameters;
wherein providing one of the different versions of firmware comprises providing one of the different versions of firmware that achieves a respective target parameter for each of the plurality of performance parameters.

5. The method of claim 1, wherein providing one of the different versions of firmware that achieves a target value for the performance parameter for deployment on the physical memory device comprises providing one of the different versions of firmware for deployment on any physical memory device having a same part number.

6. The method of claim 1, further comprising:
providing a respective indication of power consumed by the digital twin as operated by each different version of firmware; and
providing a respective indication of a thermal response of the digital twin as operated by each different version of firmware.

7. The method of claim 1, wherein iteratively producing, by the machine learning algorithm, different versions of firmware comprises iteratively producing different versions of firmware by a reinforcement learning algorithm or a genetic algorithm.

8. An apparatus for machine learning firmware optimization, comprising:
a processor;
a memory storing instructions executable by the processor to:
deploy an initial version of firmware that defines a respective acceptable range of values for each of a plurality of operational parameters on a digital twin of a physical memory device;
determine an initial value of a performance parameter based on operation of the digital twin according to the initial version of firmware;
produce a modified version of firmware;
deploy the modified version of firmware on the digital twin; and
determine a next value of the performance parameter based on operation of the digital twin according to the modified version of firmware; and
provide one of the different versions of firmware that achieves a target value for the performance parameter for deployment on the physical memory device.

9. The apparatus of claim 8, wherein the instructions to produce modified version of firmware comprise instructions to modify values of one or more of the plurality of operational parameters.

10. The apparatus of claim 9, wherein the performance parameter comprises one or more of a group of performance parameters including random read performance, sequential write performance, and input/output operations per second.

11. The apparatus of claim 8, wherein the digital twin further includes a thermal model of the physical memory device;
wherein the thermal model is configured to provide an indication of a thermal response of the digital twin as operated by the development firmware.

12. The apparatus of claim 11, wherein the plurality of operational parameters include one or more of a group of operational parameters including buffer depth, dynamic voltage frequency scaling, and thermal constraints.

13. The apparatus of claim 8, wherein the physical memory device comprises a managed NAND memory device or a DRAM memory device.

14. A non-transitory machine readable medium storing instructions executable to:
operate a digital twin of a physical memory device according to development firmware within a respective acceptable range of values for each of a plurality of operational parameters defined in the development firmware;
wherein the digital twin includes a model of hardware the physical memory device; and
wherein the model of hardware comprises abstractions of hardware components of the physical memory device;
determine a value of a performance parameter of the digital twin based on operation thereof;
iteratively optimize the development firmware with respect to a target value for the performance parameter defined in the development firmware; and
create operational firmware to operate the physical memory device based on the optimized development firmware.

15. The medium of claim 14, wherein the instructions to iteratively optimize the development firmware comprise instructions to iteratively:
produce a modified version of the development firmware;
operate the digital twin according to the modified version of the development firmware; and
determine a next value of the performance parameter based on operation of the digital twin according to the modified version of the development firmware;
until the next value of the performance parameter meets the target value.

16. The medium of claim 14, wherein the digital twin further includes a power model of the physical memory device;
wherein the power model is configured to provide an indication of power consumed by the digital twin as operated by the development firmware.

17. The medium of claim 16, wherein the digital twin further includes a thermal model of the physical memory device;
wherein the thermal model is configured to provide an indication of a thermal response of the digital twin as operated by the development firmware.

18. The medium of claim 17, wherein the thermal model is further configured to provide the indication of the thermal response based on the indication of power consumed.

19. The medium of claim 14, wherein the model of hardware comprises a register transfer level (RTL) model of the physical memory device.

20. The medium of claim 14, wherein the model of hardware comprises an embedded component model of the physical memory device that represents a physical layout of the hardware components.
